(19) United States
(12) Patent Application Publication
(10) Pub. No.: US 2024/0005417 A1
(43) Pub. Date: Jan. 4, 2024

(54) Methods and Systems for Social Media NFT Creation and Management

(71) Applicant: Taurien Buffaloe, Philadelphia, PA (US)

(72) Inventor: Taurien Buffaloe, Philadelphia, PA (US)

(21) Appl. No.: 18/343,325

(22) Filed: Jun. 28, 2023

Related U.S. Application Data
(60) Provisional application No. 63/367,279, filed on Jun. 29, 2022.

(51) Int. Cl. G06Q 50/00; G06Q 20/36

(52) U.S. Cl. CPC G06Q 50/01; G06Q 20/36; G06Q 2220/00

(57) ABSTRACT

A method and system for facilitating creation and management of social media-based tokens. The method comprises receiving user data such as user information and digital wallet credentials, storing the user data with a user account, receiving post information from a media platform, generating a minted token based on the post information, and storing the minted token, wherein the token is associated with the user account. The system comprises a communication device, a processing device, and a storage device, configured to communicate with one another and carry out the above method steps, specifically including communication with third-party media platforms and external digital wallets.

### FIELD OF THE INVENTION

The present invention relates generally to NFT applications and more specifically to methods and systems for creating and managing NFTs based from social media posts.

### BACKGROUND OF THE INVENTION

Content creators use social media as a means of displaying their work and amassing followers. However, monetizing social media content is often a drawn out and indirect process that involves capitalizing on recognition associated with content creation rather than being paid for the content itself. The most common way to monetize content is by partnering with brands for sponsored content, using the goodwill developed through long term social media presence to spread sponsored content to a wide base of followers. However, this method of monetizing social media content relies on putting out content specifically created for monetization/sponsorship rather than directly monetizing the content used to build a social media following.

The present invention is a system and method that overcomes the above referenced limitations of monetizing social media content through sponsorship by providing an additional route for content creators to be directly compensated for the content they create.

### SUMMARY OF THE INVENTION

The present invention is a system and method for facilitating creation and management of social media-based tokens. The system and method of the present invention allows users to convert their social media posts into transferrable tokens that can be managed, displayed, transferred, and otherwise manipulated.

The method of the present invention comprises the primary steps of receiving a user data associated with a user account from at least one user device, wherein the user data comprises a user information and a digital wallet credential; storing the user data associated with the user account; receiving a post information from a third-party media platform; generating a minted token, wherein the minted token is associated with the post information; and storing the minted token, wherein the minted token is associated with the user account.

The system of the present application generally comprises a communication device, a processing device, and a storage device. The communication device of the present invention is configured for receiving a user data associated with a user account from at least one user device, wherein the user data comprises a user information and a digital wallet credential and receiving a post information from a third-party media platform. The processing device of the present invention is communicatively coupled with the communication device and is configured for generating a minted token, wherein the minted token is associated with the post information. Finally, the storage device of the present application is communicatively coupled with the storage device and the communication device and is configured for storing the user data associated with the user account and storing the minted token, wherein the minted token is associated with the user account.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a block diagram of a system for facilitating creation and management of social media-based tokens, in accordance with some embodiments.

FIG. 2 is a block diagram of a system for facilitating creation and management of social media-based tokens, in accordance with some embodiments.

FIG. 3 is a flowchart of a method for facilitating creation and management of social media-based tokens, in accordance with some embodiments.

FIG. 4 is a flowchart of a method for facilitating creation and management of social media-based tokens, in accordance with some embodiments.

FIG. 5 is a flowchart of a method for facilitating creation and management of social media-based tokens, in accordance with some embodiments.

FIG. 6 is a flowchart of a method for facilitating creation and management of social media-based tokens, in accordance with some embodiments.

FIG. 7 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention. As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The present disclosure includes many aspects and features. Moreover, while many aspects and features relate to, and are described in the context of is methods and systems for facilitating NFT creation and management, embodiments of the present disclosure are not limited to use only in this context.

The present invention is a system and method for creating and managing tokens, such as NFTs, from social media posts. The present invention revolves around a web space for content creators and influencers. The web-based application enables users to take their content from social media posts on platforms such as YouTube, Instagram, Twitter, and TikTok, and convert those posts into transferrable tokens. In addition to creating tokens from social media content, the application allows users to export their tokens for sale on a third-party marketplace. Further, users may use the application to comment, like, and otherwise interact with other users' content within the web-based application.

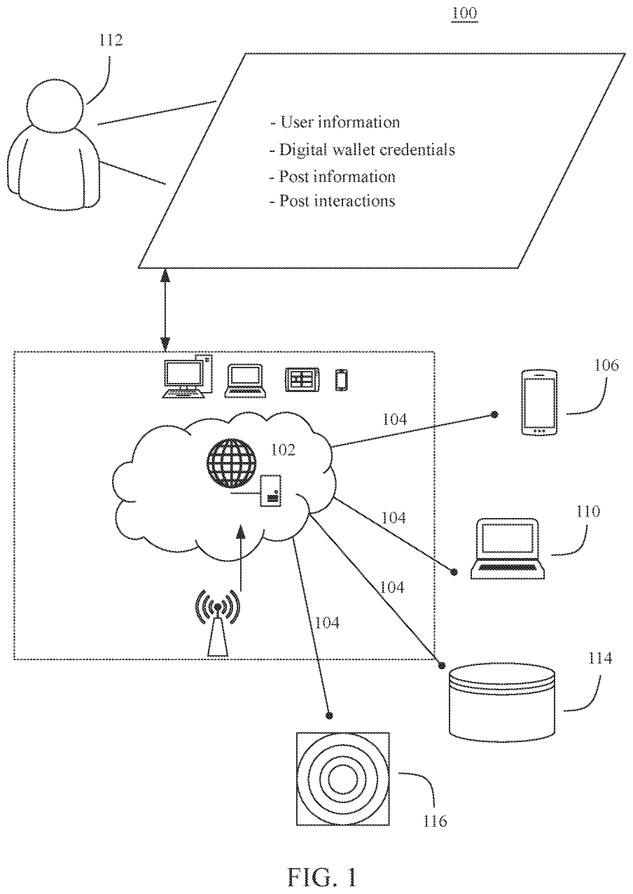

FIG. 1 is an illustration of an online platform 100 consistent with various embodiments of the present disclosure. By way of non-limiting example, the online platform 100 for managing tokens based on social media posts may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network, such as, but not limited to, the Internet. Further, users of the online platform 100 may include relevant parties such as, but not limited to, end-users, retail customers, retailers, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device.

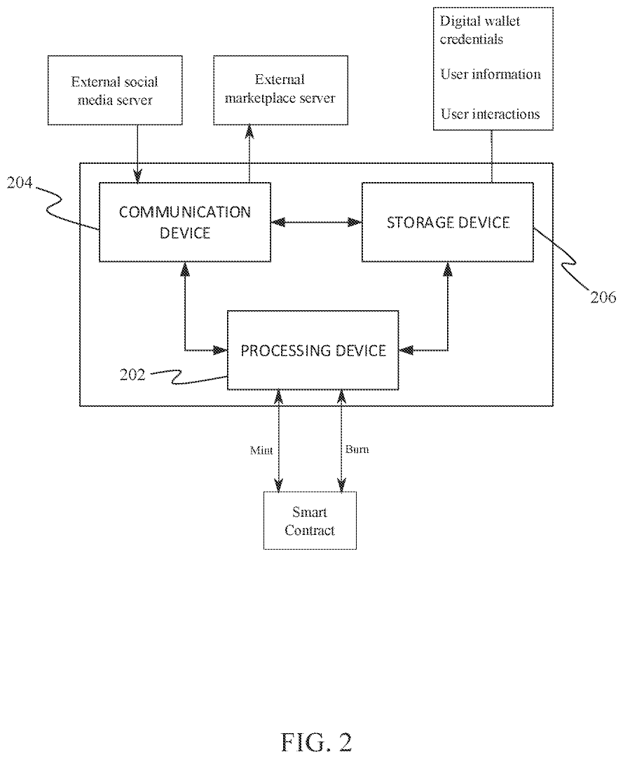

FIG. 2 is a block diagram of a system 200 for facilitating the creation and management of minted tokens based on social media content of the present invention, in accordance with some embodiments. Accordingly, the system may include a processing device 202, a communication device 204, and a storage device 206. Further, the communication device 204 may be communicatively coupled with the processing device 202. Further, the communication device 204 may be communicatively coupled with the storage device 206. Further, the storage device 206 may be communicatively coupled with the processing device 202. Further, the storage device 206 is configured to store information that can be retrieved for communication by the communication device 204 or for processing by the processing device 202. The storage device 206 is specifically configured to store user information, digital wallet credentials, post information, and tokens, though other information relating to users, posts or any other content may be stored in the storage device 206. Further, the communication device 204 is configured to send and receive information to and from various sources. Specifically, the communication device 204 is configured to receive user information, digital wallet credentials and post information from the user 112 by at least one user device 208, it is configured to receive post information from external social media servers, and it is configured to send and receive tokens and reimbursements to and from marketplace servers. The communication device 204 may also be configured to send and receive information relevant to the application with other servers and communication devices not mentioned here. Finally, the processing device 202 is configured to manipulate post information and tokens. Specifically, the processing device is configured to mint posts into tokens based on post information and delete minted posts by burning them. The processing device 202 operates in conjunction with smart contracts in creating and deleting minted tokens.

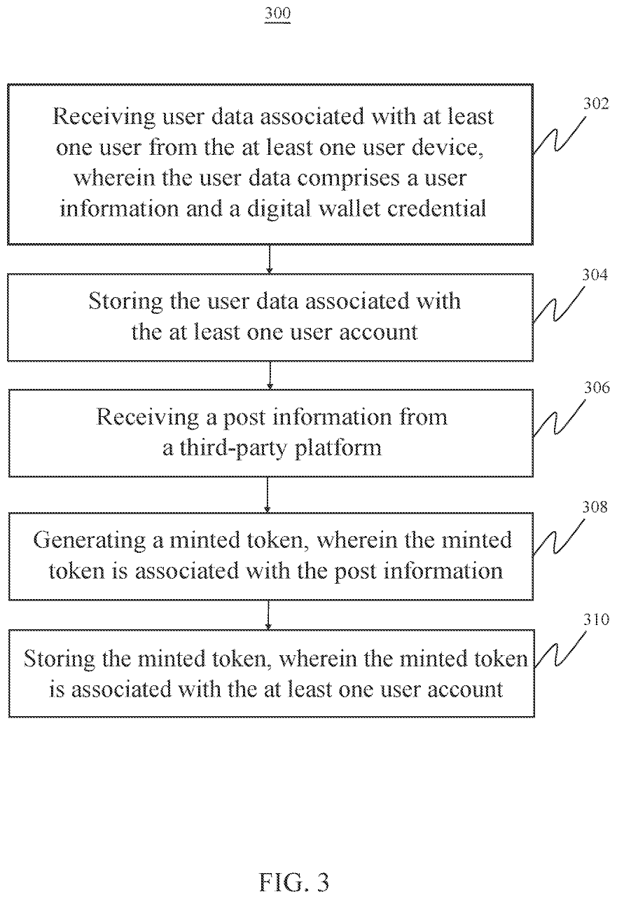

FIG. 3 is a flowchart of a method 300 of facilitating creation and management of social media-based tokens of the present invention. The method 300 may include a step of registering a user with the application. Accordingly, the step of registering may include, at 302, receiving, by the communication device, user data associated with at least one user account from at least one user device, wherein the user data comprises a user information and a digital wallet credential. Further, the step of registering may include, at 304, storing, by the storage device, the user data associated with the at least one user account. Further, at 306, the method 300 may include the step of receiving, with the communication device, a post information from a third-party platform. Post information may include, but is not limited to, a post title, a post category, a post caption, one or more post hashtags, and the source social media post. In the preferred embodiment, the post information is received by input from the user and by communication with the third-party platform. This may include receiving a link to the source social media post by the user before receiving the source social media post itself at the external social media server. Further, at 308, the method 300 may include the step of generating, by the processor, a minted token, wherein the minted token is associated with the post information. The step of generating the minted token effectively converts the post information into a minted NFT of the source post. In some embodiments of the present invention, the step of generating the minted token may include a payment of a minting fee from the at least one user account. Finally, at 310, the method 300 may include the step of storing, by the storage device, the minted token, wherein the minted token is associated with the at least one user account. The minted tokens noted above may be any type of transferrable digital token, such as a non-fungible token (or NFT).

In addition to the steps described above for creating an NFT from a social media post, the method of the present invention may include additional steps to cover alternative features and embodiments of the invention. The method may include a step of burning, by the processor, the minted post. Burning a minted post takes advantage of a smart contract to delete the created NFT. Further, the method may include receiving, by the communication device, interactions with the minted post and storing, by the storage device, the interactions with the minted post. Interactions may be likes, comments, or other any other actions associated with the minted post by a secondary user. Further, the method may include a step of sending, by the communication device, the minted post to a marketplace server. Sending the minted post to the marketplace server allows the user to sell or otherwise transfer the minted post (or NFT) created through the present method.

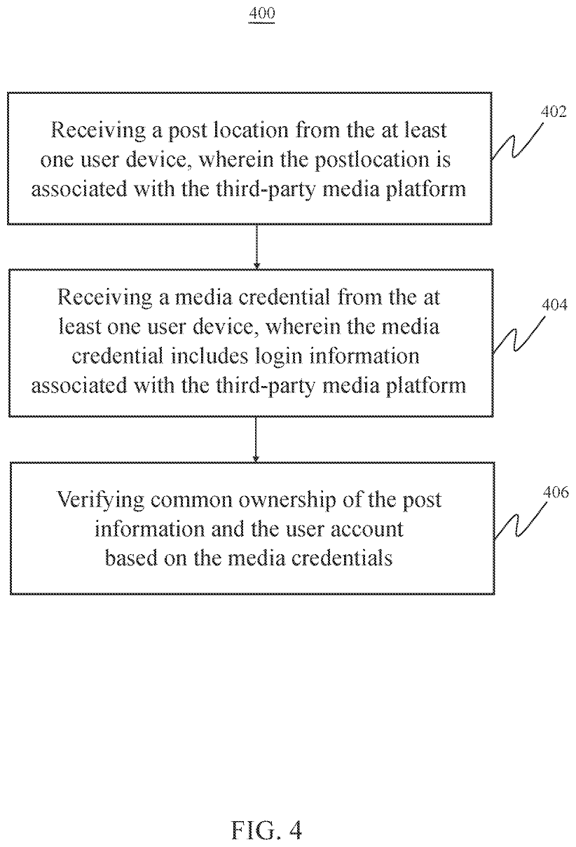

FIG. 4 is a flowchart of a method 400 for receiving post information. Within the present invention, post information is gathered from third-party platforms and a user is only able to create a minted token from a post for which they are the author or owner. Accordingly, at 402, the method 400 may include receiving, using the communication device, a post location from the at least one user device, wherein the post location is associated with the third-party media platform. Specifically, the post location is a web address or other identifier of the digital location of the post information. Further, at 404, the method 400 may include receiving, using the communication device, a media credential from the at least one user device, wherein the media credential includes login information associated with the third-party media platform. Finally, at 406, the method 400 may include verifying, using the processing device, common ownership of the post information and the user account based on the media credentials. In the preferred embodiment, verifying common ownership is done by utilizing the login information associated with the third-party platform to access the post information, ensuring that the post information can only be received by the communication device if the user has the third-party platform login information associated with the author or owner of the post information.

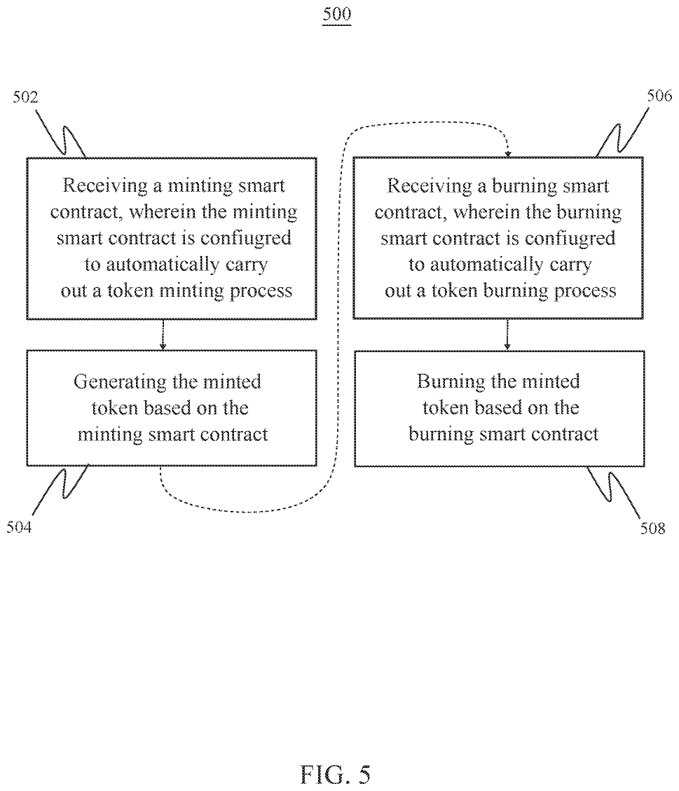

FIG. 5 is a flowchart of a specific method 500 of minting posts and burning posts, wherein smart contracts are utilized to automatically carry out the minting. Accordingly, at 502, the method 500 may include receiving, by the communication device, a minting smart contract, wherein the minting smart contract is configured to automatically carry out a token minting process. Further, at 504, the method 500 may include generating, using the processing device, the minted token based on the minting smart contract. Further, at 506, the method 500 may include receiving, using the communication device, a burning smart contract, wherein the burning smart contract is configured to automatically carry out a token burning process. Further, at 508, the method 500 may include burning, using the processing device, the minted token based on the burning smart contract, wherein the burning removes the minted token from the user account. The processes of minting and burning using smart contracts as described in the method 500 are not limited to any specific smart contracts, but instead may take advantage of known or novel smart contracts for the minting and burning of tokens upon action taken by the user. For example, a minting smart contract may automatically carry out the minting process for post information upon the initial posting of that post information on a third-party platform or the minting smart contract may carry out the minting process upon an order from the user through the at least one user device. Similarly, a burning smart contract may, automatically or by action through the at least one user device, carry out the burning process for a token. Though the minting and burning processes are presented above in a specific order, the method 500 may be carried out in any order and any number of iterations, allowing various tokens to be minted and burned as needed.

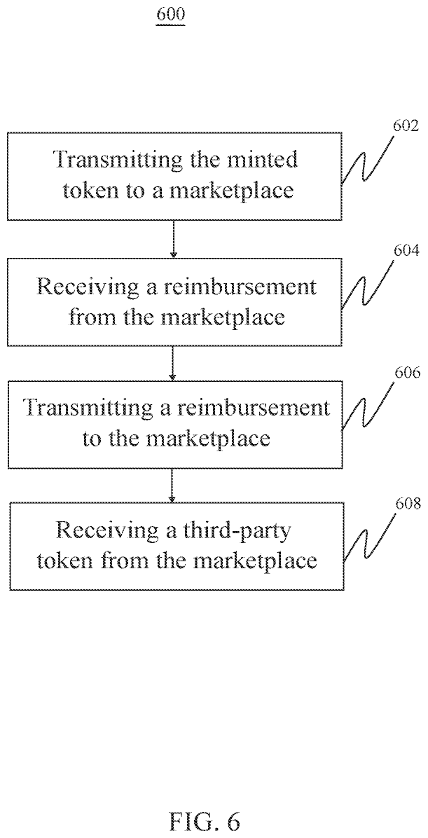

FIG. 6 is a flowchart of the method 600 of exchanging tokens on a marketplace. The marketplace may be a third-party marketplace server external to the web-platform of the present invention or the marketplace may be integrated into the web-platform of the present invention, directly utilizing communication between the at least one user account and an at least one third party account. Accordingly, at 602, the method 600 may include transmitting, using the communication device, the minted token to a marketplace. Further, at 604, the method 600 may include receiving, using the communication device, a reimbursement from the marketplace. Further, at 606, the method 600 may include transmitting, using the communication device, a reimbursement to a marketplace. Further, at 608, the method 600 may include receiving, using the communication device, a third-party token from the marketplace. The method 600 may be carried out in the order as disclosed above or the steps of the method may be carried out in a varied order to account for different interactions within the marketplace of the present invention. For example, transmitting a minted token and receiving a reimbursement may take place as a single marketplace interaction in which the user effectively sells their minted token for value. Conversely, transmitting a reimbursement and receiving a third-party token may take place as a single marketplace interaction in which the user effectively buys a token for value. In some circumstances, the marketplace interaction may be an exchange of a minted token for a third-party token, or the reimbursement in any of the above steps may be in the form of some digital token or currency.

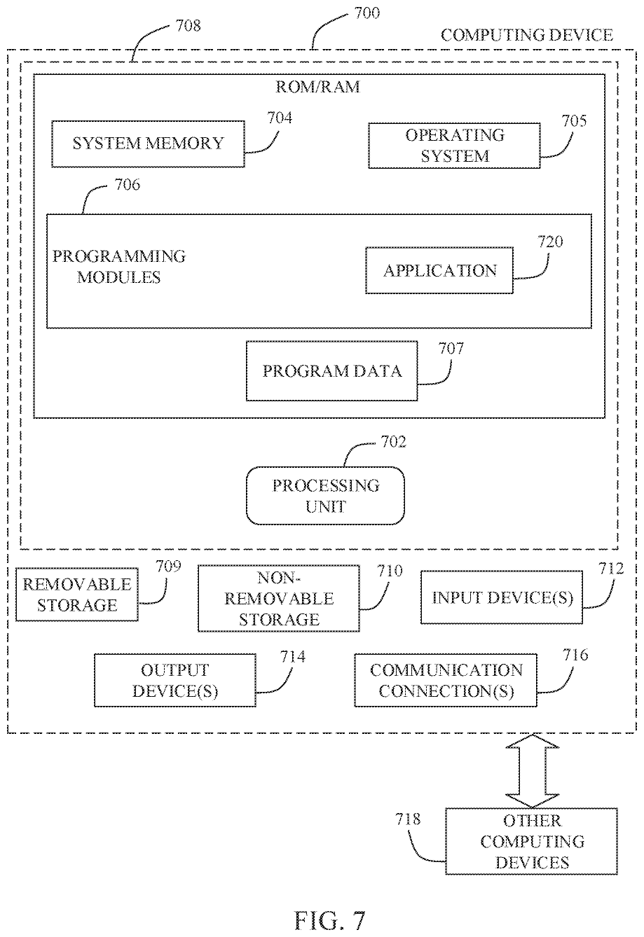

With reference to FIG. 7, a system consistent with an embodiment of the disclosure may include a computing device or cloud service, such as computing device 700. In a basic configuration, computing device 700 may include at least one processing unit 702 and a system memory 704. Depending on the configuration and type of computing device, system memory 704 may comprise, but is not limited to, volatile (e.g. random-access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling computing device's 700 operation. In one embodiment, programming modules 706 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable and non-removable media implemented in any method or technology for storage of information, such as computer-readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of computing device 700. Computing device 700 may also have input device(s) 712 such as a keyboard, a mouse, a pen, a sound input device, a touch input device, a location sensor, a camera, a biometric sensor, etc. Output device(s) 714 such as a display, speakers, a printer, etc. may also be included. The aforementioned devices are examples and others may be used.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 704, including operating system 705. While executing on processing unit, programming modules 706 (e.g., application such as a media player) may perform processes including, for example, one or more stages of methods, algorithms, systems, applications, servers, databases as described above. The aforementioned process is an example, and processing unit 702 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method of facilitating creation and management of social media-based tokens, the method comprising:
receiving, using a communication device, a user data associated with at least one user account from at least one user device, wherein the user data comprises a user information and a digital wallet credential;
storing, using a storage device, the user data associated with the at least one user account;
receiving, using the communication device, a post information from a third-party media platform;
generating, using a processing device, a minted token, wherein the minted token is associated with the post information; and
storing, using the storage device, the minted token, wherein the minted token is associated with the at least one user account.

2. The method of claim 1, further comprising:
the digital wallet credential being data associated with accessing a digital wallet;
pairing, using the processing device, the digital wallet with the at least one user account; and
mapping, using the processing device, the minted token to the digital wallet.

3. The method of claim 1, wherein the post information comprises at least one of a post title, a post category, a post caption, at least one post hashtag, and a source social media post.

4. The method of claim 1, the step of receiving post information further comprising:
receiving, using the communication device, a post location from the at least one user device, wherein the post location is associated with the third-party media platform;
receiving, using the communication device, a media credential from the at least one user device, wherein the media credential includes login information associated with the third-party media platform; and
verifying, using the processing device, common ownership of the post information and the at least one user account based on the media credentials.

5. The method of claim 1, the step of generating a minted token further comprising:
receiving, by the communication device, a minting smart contract, wherein the minting smart contract is configured to automatically carry out a token minting process; and
generating, using the processing device, the minted token based on the minting smart contract.

6. The method of claim 1, further comprising:
receiving, using the communication device, a burning smart contract, wherein the burning smart contract is configured to automatically carry out a token burning process;
burning, using the processing device, the minted token based on the burning smart contract, wherein the burning removes the minted token from the at least one user account.

7. The method of claim 1, further comprising:
receiving, using the communication device, at least one interaction from the at least one user device, wherein the at least one interaction is associated with the minted token.

8. The method of claim 7, wherein the at least one interaction is at least one of a like and a comment.

9. The method of claim 1, further comprising:
transmitting, using the communication device, the minted token to a marketplace; and
receiving, using the communication device, a reimbursement from the marketplace.

10. The method of claim 1, further comprising:
transmitting, using the communication device, a reimbursement to a marketplace;
receiving, using the communication device, a third-party token from the marketplace; and
storing, using the storage device, the third-party token, wherein the third-party token is associated with the at least one user account.

11. A system for facilitating creation and management of social media-based tokens, the system comprising:
a communication device configured for:
receiving a user data associated with at least one user account from at least one user device, wherein the user data comprises a user information and a digital wallet credential; and
receiving a post information from a third-party media platform;
a processing device communicatively coupled with the communication device, wherein the processing device is configured for:
generating a minted token, wherein the minted token is associated with the post information; and
a storage device communicatively coupled with the communication device, wherein the storage device is configured for:
storing the user data associated with the at least one user account; and
storing the minted token, wherein the minted token is associated with the at least one user account.

12. The system of claim 11, further comprising:
the digital wallet credential being data associated with accessing a digital wallet; and
the processing device being further configured to:
pair the digital wallet with the at least one user account; and
map the minted token to the at least one user account.

13. The system of claim 11, wherein the post information comprises at least one of a post title, a post category, a post caption, at least one post hashtag, and a source social media post.

14. The system of claim 11, further comprising:
the communication device being further configured to:
receive a post location from the at least one user device, wherein the post location is associated with the third-party media platform; and
receive a media credential from the at least one user device,
wherein the media credential includes login information associated with the third-party media platform; and
the processing device being further configured to verify common ownership of the post information and the at least one user account based on the media credentials.

15. The system of claim 11, further comprising:
the communication device being further configured to receive a minting smart contract, wherein the minting smart contract is configured to automatically carry out a token minting process; and
the processing device being further configured to generate the minted token based on the minting smart contract.

16. The system of claim 11, further comprising:
the communication device being further configured to receive a burning smart contract, wherein the burning smart contract is configured to automatically carry out a token burning process; and
the processing device being further configured to burn the minted token based on the burning smart contract, wherein the burning removes the minted token from the at least one user account.

17. The system of claim 11, further comprising:
the communication device being further configured to receive at least one interaction from the at least one user device, wherein the at least one interaction is associated with the minted token.

18. The system of claim 17, wherein the at least one interaction is at least one of a like and a comment.

19. The system of claim 11, further comprising:
the communication device being further configured to:
transmit the minted token to a marketplace; and
receive a reimbursement from the marketplace.

20. The system of claim 11, further comprising:
the communication device being further configured to:
transmit a reimbursement to a marketplace; and
receive a third-party token from the marketplace; and
the storage device being further configured to store the third-party token, wherein the third-party token is associated with the at least one user account.
